(19) United States
(12) Patent Application Publication
(10) Pub. No.: US 2025/0326332 A1
(43) Pub. Date: Oct. 23, 2025

(54) VEHICLE SEAT

(71) Applicants: Tomoya TAKEUCHI, Anjo-shi Aichi-ken (JP); Takayuki OKABE, Kariya-shi Aichi-ken (JP); Takuya MUTO, Kariya-shi Aichi-ken (JP); Hiroshi NOZU, Higashiohmi-shi Shiga-ken (JP)

(72) Inventors: Tomoya TAKEUCHI, Anjo-shi Aichi-ken (JP); Takayuki OKABE, Kariya-shi Aichi-ken (JP); Takuya MUTO, Kariya-shi Aichi-ken (JP); Hiroshi NOZU, Higashiohmi-shi Shiga-ken (JP)

(73) Assignees: TOYOTA JIDOSHA KABUSHIKI KAISHA, Toyota-shi Aichi-ken (JP); RECARO Automotive Japan Co. Ltd., Higashiomi Shiga (JP)

(21) Appl. No.: 19/179,065

(22) Filed: Apr. 15, 2025

(30) Foreign Application Priority Data
Apr. 19, 2024 (JP) 2024-068253

(51) Int. Cl. B60N 2/16; B60N 2/68

(52) U.S. Cl. CPC B60N 2/16; B60N 2/688

(57) ABSTRACT

A vehicle seat includes a seat body and side brackets provided on the outer sides of the seat body. Each of the side brackets includes an upper bracket and a lower bracket. The upper bracket is fastened to an outer side surface of the seat body and is also fastened to the lower bracket. The lower bracket is fastened directly or indirectly to a vehicle floor. The lower bracket and the upper bracket are fastened at a front fastening portion and a rear fastening portion, which are located apart from each other in the front-back direction of the seat body. The front fastening portion and the rear fastening portion each include an adjuster configured to change a position of the upper bracket with respect to the lower bracket in an up-down direction or in up-down and front-back directions to fasten the front and rear fastening portions together.

### CROSS REFERENCE TO RELATED APPLICATION

This application claims priority to Japanese Patent Application No. 2024-068253 filed on Apr. 19, 2024, which is incorporated herein by reference in its entirety including the specification, claims, drawings, and abstract.

### TECHNICAL FIELD

The present disclosure relates to a vehicle seat, and in particular to a lifter adjustment structure for a vehicle seat.

### BACKGROUND ART

Vehicles such as automobiles are equipped with seats. As a vehicle seat, a full bucket seat (hereinafter referred to as a “bucket seat”) is known, in which a seat cushion on which a passenger is seated and a seat back serving as a backrest for a passenger are molded as a single piece.

A bucket seat includes a seat body, and side brackets provided on the outer sides of the seat body. The seat body is fixed to a vehicle floor via the side brackets. Patent Document 1 discloses a structure for fixing bucket seats to a vehicle floor.

### CITATION LIST

PATENT DOCUMENT 1: JP 2001-10389 A

### SUMMARY

FIG. 6A is a side view illustrating an example of a bucket seat 110 of the related art. The bucket seat 110 includes a seat body 112 and a side bracket 120 provided on either side of the outer side of the seat body 112 and fastened to the vehicle floor via seat rails (not illustrated). To adjust the vertical position of the seat body 112 with respect to the vehicle floor, an elongate hole 156 extending in the up-down direction is provided in the front part of the side bracket 120. A plurality of bolt insertion holes 166 are arranged in the up-down direction in the rear part of the side bracket 120.

In the front part of the side bracket 120, a fastening bolt 154 is inserted into the elongate hole 156 and fastened to a female thread formed in a side surface 113 of the seat body 112. In the rear part of the side bracket 120, a fastening bolt 164 is inserted into one of the plurality of bolt insertion holes 166 and fastened to a female thread formed in the side surface 113 of the seat body 112. The vertical position of the seat body 112 with respect to the side bracket 120 (i.e., the vehicle floor) can be changed according to the position of the fastening bolt 154 in the elongate hole 156 and the bolt insertion hole 166 through which the fastening bolt 164 is inserted.

Here, consider how to increase the vertical adjustment range of the seat body 112 and enable adjustment of the seat body 112 in the front-back direction. In this case, as illustrated in FIG. 6B, an extension 181 extending forward and upward is needed in the front part of the side bracket 120, and another elongate hole or bolt insertion hole needs to be formed therein. Similarly, in the rear part of the side bracket 120, an extension 182 extending forward and upward is also needed, and another elongate hole or bolt insertion hole needs to be formed therein.

For example, however, a side edge 114 of the seat cushion of the seat body 112 may project outward. In this case, if the seat body 112 is fastened to the side bracket 120 at a low position, as illustrated by an arrow N1 in FIG. 6B, the side edge 114 of the seat cushion may interfere with the extension 181. In addition, an inner buckle 119 of the seat belt is fastened in the rear part of the side bracket 120. If the extension 182 is located behind the rear part of the side bracket 120, the extension 182 may interrupt the insertion of the tongue of the seat belt into the inner buckle 119, as illustrated by an arrow N2. In practice, it is either impossible or difficult to provide the extensions 181, 182, respectively, in the front and rear part of the side bracket 120.

Although the expansion of the adjustment range of the seat body 112 in the front-back and up-down directions is described in the above, the same problem may arise when the adjustment range of the seat body 112 is expanded only in the up-down direction as illustrated in FIG. 6A; it is impossible or difficult to provide such an upward extension in both front and rear parts of the side bracket 120.

Therefore, it is desired to provide a structure that can expand the adjustment range of the seat body with respect to the vehicle floor in the up-down direction or in the up-down and front-back directions. Hereafter, the position adjustment of the seat body in the up-down direction or in the up-down and front-back directions will be referred to as lifter adjustment.

It is an object of the present disclosure to expand the lifter adjustment range for the vehicle seat.

A vehicle seat according to the present disclosure includes a seat body and a side bracket provided on either side of the outer side of the seat body. The side bracket includes an upper bracket and a lower bracket. The upper bracket is fastened to an outer side surface of the seat body and is also fastened to the lower bracket. The lower bracket is fastened directly or indirectly to a vehicle floor. The lower bracket and the upper bracket are fastened at a front fastening portion and a rear fastening portion which are located apart from each other in the front-back direction of the seat body. Each of the front fastening portion and the rear fastening portion includes an adjuster configured to change a position of the upper bracket with respect to the lower bracket in an up-down direction or in up-down and front-back directions to fasten the front and rear fastening portions together.

According to this configuration, the side bracket include two parts, that is, the lower bracket and the upper bracket, and the lifter adjustment of the seat body is carried out by changing the position of the upper bracket with respect to the lower bracket without changing the relative position of the seat body and the upper bracket. There is no need to extend the upper bracket upward in order to expand the lifter adjustment range. Each of the lower bracket and the upper bracket can include an adjuster in the fastening portion (the front fastening portion and the rear fastening portion) according to a desired lifter adjustment range, whereby the lifter adjustment range can be expanded.

In the vehicle seat according to the present disclosure, the buckle of the seat belt may be fastened to the upper bracket of the side bracket.

According to this configuration, the relative position of the buckle with respect to the seat body does not change before and after the seat lifter adjustment. In other words, the relative position of the buckle with respect to the seat body is maintained.

In the vehicle seat according to the present disclosure, the adjuster of the front fastening portion may include a plurality of front bolt insertion holes formed in the front part of the lower bracket. The plurality of front bolt insertion holes of the lower bracket may include a selected front bolt insertion hole which is selected according to the position of the upper bracket with respect to the lower bracket. The front fastening portion may include a front bolt insertion hole formed in the front part of the upper bracket, and a front fastening bolt which is inserted into the front bolt insertion hole of the upper bracket and the selected front bolt insertion hole of the lower bracket.

In the vehicle seat according to the present disclosure, the adjuster of the rear fastening portion may include a plurality of rear bolt insertion holes formed in the rear part of the upper bracket and a plurality of rear bolt insertion holes formed in the rear part of the lower bracket. The plurality of rear bolt insertion holes of the upper bracket may include a selected rear bolt insertion hole which is selected according to the position of the upper bracket with respect to the lower bracket. The plurality of rear bolt insertion holes of the lower bracket may include a selected rear bolt insertion hole which is selected according to the position of the upper bracket with respect to the lower bracket. The rear fastening portion may include a rear fastening bolt inserted into the selected rear bolt insertion hole of the upper bracket and the selected rear bolt insertion hole of the lower bracket.

According to the present disclosure, the lifter adjustment range of the seat can be expanded.

### BRIEF DESCRIPTION OF DRAWINGS

FIG. 1 is a perspective view of a bucket seat in its lowest position;

FIG. 2 is a perspective view of the bucket seat in its highest position;

FIG. 3A is a perspective view of a side bracket including a lower bracket and an upper bracket;

FIG. 3B is a perspective view of the side bracket in a second lifter position;

FIG. 3C is a perspective view of the side bracket in a third lifter position;

FIG. 3D is a perspective view of the side bracket in a fourth lifter position;

FIG. 4 is a perspective view of the bucket seat in which a torso angle is adjusted;

FIG. 5 illustrates a difference in lifter adjustment range between an embodiment and the related art;

FIG. 6A is a side view of a bucket seat of the related art; and

FIG. 6B is a side view of the bucket seat of the related art.

### DESCRIPTION OF EMBODIMENTS

An embodiment of the present disclosure will be described below with reference to the accompanying drawings. The present disclosure is not limited to the embodiment described herein. In all drawings, equivalent elements are marked with the same reference signs and the explanations thereof will not be repeated. In the following description, unless otherwise indicated, words and phrases that refer to directions and orientations, such as front and back, left and right, up and down, and the like represent directions and orientations of a vehicle. In the embodiments described below, the front-back, left-right, and up-down directions of the vehicle and the seat body are consistent. In each drawing, an arrow FR represents a forward direction, an arrow UP represents an upward direction, and an arrow LH represents a leftward direction.

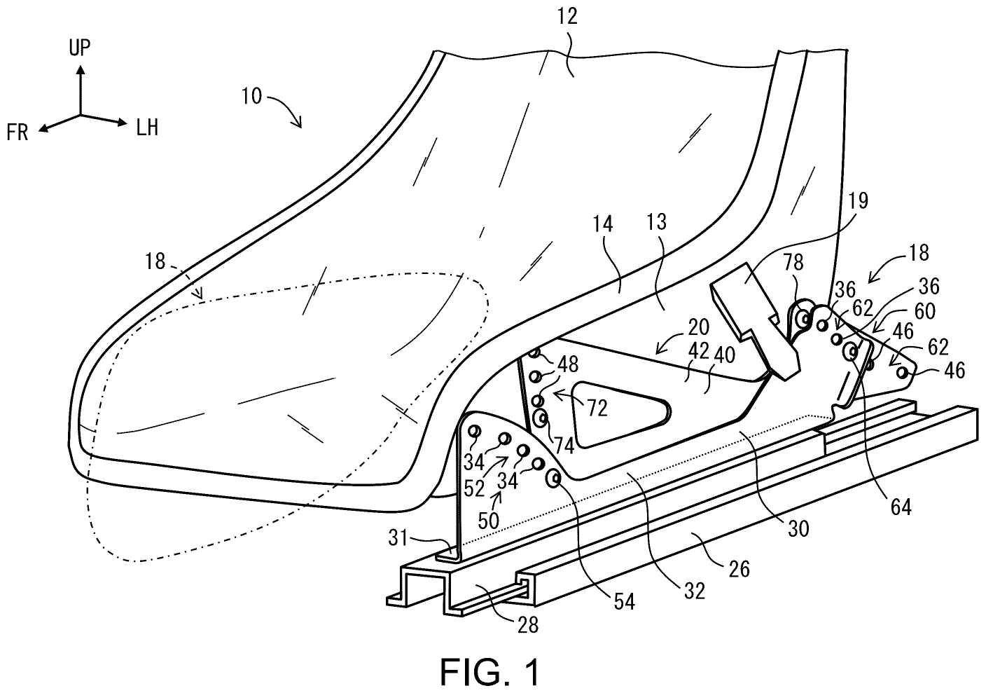

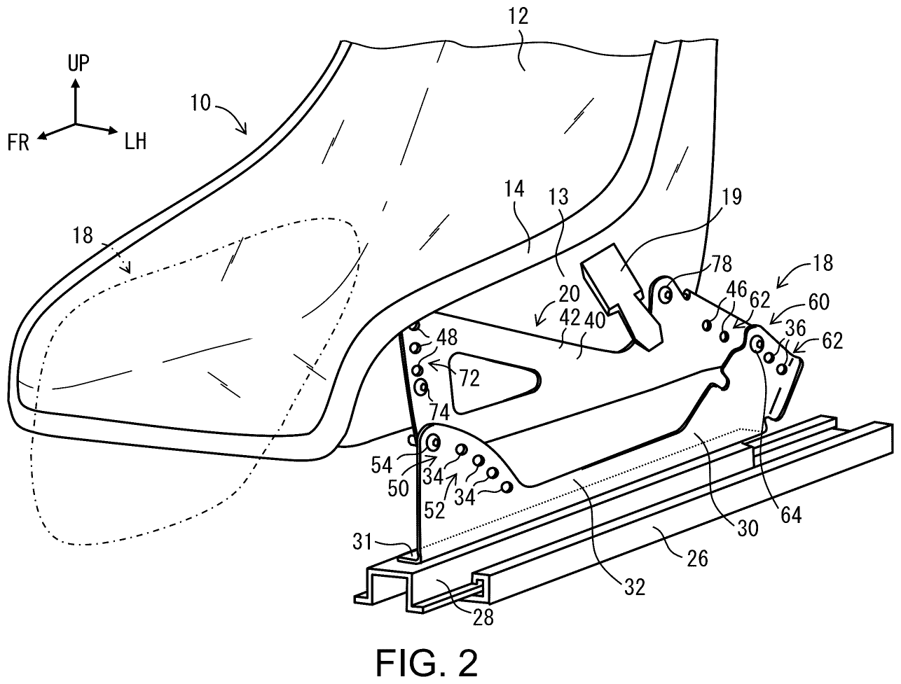

FIG. 1 is a perspective view of a bucket seat 10 in its lowest position. FIG. 2 is a perspective view of the bucket seat 10 in its highest position. In FIGS. 1, 2, and 4, which will be described later, the upper part of the seat back of a seat body 12 is omitted. The bucket seat 10 is mounted in an automobile serving as a vehicle. The bucket seat 10 provided as a vehicle seat illustrated in FIG. 1 is a full bucket seat and is, for example, a driver seat. A side door (not illustrated) of the vehicle is provided on the right-hand side of the bucket seat 10, and a center console (not illustrated) is provided on the left-hand side of the bucket seat 10.

The bucket seat 10 includes the seat body 12 and two side member groups 18 provided on the left and right outer sides of the seat body 12. In FIGS. 1, 2, and 4, the side member group 18 on the right-hand side is indicated by a dash-dot line, and the actual entity thereof is not illustrated. The dash-dot line indicates an approximate location of the side member group 18 on the right-hand side. The side member group 18 on the right-hand side has a symmetrical shape relative to the side member group 18 on the left-hand side. The side member group 18 on the right-hand side and the side member group 18 on the left-hand side have similar structures except for an inner buckle 19. The side member group 18 on the right-hand side does not include the inner buckle.

The seat body 12 is a seat with the seat cushion and the seat back molded as a single piece. The seat body 12 is a seat that enhances the function of fixing the body of the passenger by wrapping around the thigh, waist, torso, and the like of the passenger by setting both sides of the seat cushion and both sides of the seat back higher than the center. The upper edge of the side of the seat cushion of the seat body 12 is bent outward to form a side edge 14 with a reverse U-shaped cross-section.

As illustrated in FIG. 1, the side member group 18 includes the side bracket 20, the inner buckle 19 of the seat belt, a movable rail 28, and a fixed rail 26. The movable rail 28 and the fixed rail 26 constitute a seat rail.

The side bracket 20 includes an upper bracket 40 and a lower bracket 30. The upper bracket 40 is fastened to an outer side surface 13 of the seat body 12 and to the lower bracket 30. The lower bracket 30 is fastened to the upper portion of the movable rail 28. The movable rail 28 is configured to slide in the front-back direction with respect to the fixed rail 26. The fixed rail 26 is fastened to the vehicle floor (not illustrated).

A lock mechanism, which is not illustrated, is provided between the movable rail 28 and the fixed rail 26. The lock mechanism holds the movable rail 28 in a locked state in which the sliding movement of the movable rail 28 with respect to the fixed rail 26 is restricted. The sliding movement of the movable rail 28 is allowed by unlocking the lock mechanism using an operating lever which is not illustrated. The seat rail may employ a well-known technology.

In the present embodiment, the lower bracket 30 is fastened indirectly to the vehicle floor via the seat rail, but the lower bracket 30 may be fastened directly to the vehicle floor.

The inner buckle 19 of the seat belt is fixed to the rear part of the upper bracket 40, as illustrated in FIG. 2. The inner buckle 19 is fastened to the upper bracket 40 using, for example, a fastening bolt and a nut.

The lower bracket 30 and the upper bracket 40 are fastened together at a front fastening portion 50 and a rear fastening portion 60, which are located apart from each other in the front-back direction of the seat body 12. The front fastening portion 50 and the rear fastening portion 60 include adjusters 52, 62, respectively, that allow the position of the upper bracket 40 with respect to the lower bracket 30 to be changed in the front-back and up-down directions and fasten them together.

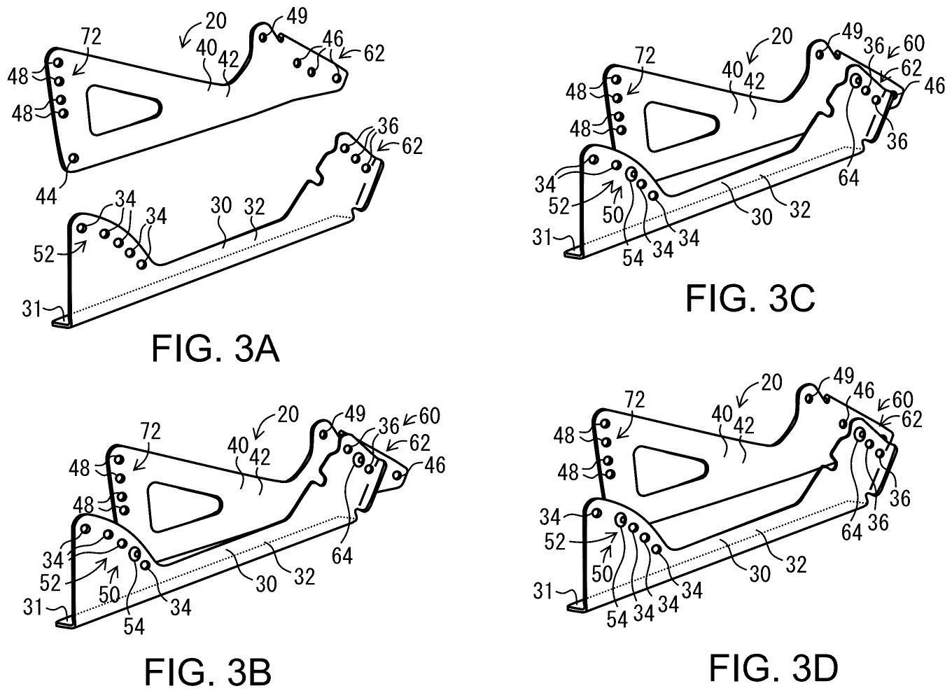

FIG. 3A is a perspective view of the lower bracket 30 and the upper bracket 40. The lower bracket 30 and the upper bracket 40 are metal members formed, for example, by bending and drilling a metal sheet.

The lower bracket 30 has a side plate 32 and a bottom plate 31 bent at a right angle with respect to the side plate 32. The bottom plate 31 of the lower bracket 30 is fastened to the top of the movable rail 28, as illustrated in FIG. 1. The side plate 32 of the lower bracket 30 has a plurality of bolt insertion holes 34 formed in the upper front portion thereof and a plurality of bolt insertion holes 36 formed in the upper rear portion thereof, as illustrated in FIG. 3A.

The plurality of bolt insertion holes 34 are arranged diagonally in the front-back and up-down directions, and a fastening bolt 54 (see FIG. 1) is selectively inserted into one of the bolt insertion holes 34. The fastening bolt 54 is inserted into a bolt insertion hole 44 of the upper bracket 40 (see FIG. 3A) and screwed into a nut provided on the back side of the upper bracket 40. This fastens the front part of the lower bracket 30 and the front part of the upper bracket 40 together. The front fastening portion 50 (see FIG. 1) includes the fastening bolt 54, the plurality of bolt insertion holes 34 of the lower bracket 30, and the bolt insertion hole 44 of the upper bracket 40 (see FIG. 3A). The plurality of bolt insertion holes 34 of the lower bracket 30 function as the adjuster 52 for the lifter adjustment of the front portion of the seat body 12. As used herein, the bolt insertion holes 34 are also referred to as front bolt insertion holes 34, the bolt insertion hole 44 is also referred to as a front bolt insertion hole 44, and the fastening bolt 54 is also referred to as a front fastening bolt 54.

In the lifter adjustment, one bolt insertion hole 34 selected from the plurality of the bolt insertion holes 34 of the lower bracket 30 is aligned with the bolt insertion hole 44 of the upper bracket 40. The fastening bolt 54 is then inserted into the selected bolt insertion hole 34 and the bolt insertion hole 44 and screwed into the nut. As used herein, the bolt insertion hole 34 through which the fastening bolt 54 is inserted among the plurality of bolt insertion holes 34 is referred to as a selected bolt insertion hole or a selected front bolt insertion hole.

As illustrated in FIG. 3A, the plurality of bolt insertion holes 36 of the lower bracket 30 are arranged diagonally in the front-back and up-down directions, and a fastening bolt 64 (see FIG. 1) is selectively inserted into one of bolt insertion hole 36. The fastening bolt 64 is inserted into one of a plurality of bolt insertion holes 46 (see FIG. 3A) of the upper bracket 40 and screwed to a nut provided on the back side of the upper bracket 40. This fastens the rear part of the lower bracket 30 and the rear part of the upper bracket 40 together. The rear fastening portion 60 (see FIG. 1) includes the fastening bolt 64, the plurality of bolt insertion holes 36 of the lower bracket 30, and the plurality of bolt insertion holes 46 of the upper bracket 40. The plurality of bolt insertion holes 36 of the lower bracket 30 and the plurality of bolt insertion holes 46 of the upper bracket 40 function as the adjuster 62 for the lifter adjustment of the rear part of the seat body 12. As used herein, the bolt insertion holes 36 are also referred to as rear bolt insertion holes 36, the bolt insertion holes 46 are also referred to as rear bolt insertion holes 46, and the fastening bolt 64 is also referred to as a rear fastening bolt 64.

In the lifter adjustment, the selected one of the plurality of bolt insertion holes 36 of the lower bracket 30 is aligned with the selected one of the plurality of bolt insertion holes 46 of the upper bracket 40. The fastening bolt 64 is then inserted into the selected bolt insertion hole 36 and the selected bolt insertion hole 46 and screwed to the nut. As used herein, the bolt insertion hole 36 through which the fastening bolt 64 is inserted among the plurality of bolt insertion holes 36 is referred to as a selected bolt insertion hole or a selected rear bolt insertion hole. Similarly, among the plurality of bolt insertion holes 46, the bolt insertion hole 46 through which the fastening bolt 64 is inserted is referred to as a selected bolt insertion hole or a selected rear bolt insertion hole.

As illustrated in FIG. 3A, the upper bracket 40 has a side plate 42. The side plate 42 of the upper bracket 40 has the bolt insertion hole 44 formed in the lower front portion, the plurality of bolt insertion holes 46 formed in the lower rear portion, a plurality of bolt insertion holes 48 formed in the upper front portion, and a bolt insertion hole 49 formed in the upper rear portion.

The plurality of bolt insertion holes 48 are arranged in the up-down direction, and a fastening bolt 74 (see FIG. 1) is selectively inserted into one of them. The fastening bolt 74 is screwed into a female thread formed in the front portion of the outer side surface 13 of the seat body 12. This fastens the upper bracket 40 to the front part of the seat body 12. The plurality of bolt insertion holes 48 function as an adjuster 72 for adjusting the torso angle (backrest inclination angle) of the seat body 12 about the rear part of the seat body 12 (fastening bolt 78) as the central axis.

In the torso angle adjustment, the selected bolt insertion hole 48 among the plurality of bolt insertion holes 48 and the female thread of the seat body 12 are aligned. The fastening bolt 74 is then inserted into the selected bolt insertion hole 48 and screwed into the female thread of the seat body 12.

In the rear upper part of the upper bracket 40, the fastening bolt 78 (see FIG. 1) is inserted into the bolt insertion hole 49 (see FIG. 3A). The fastening bolt 78 is screwed into a female thread formed in the rear part of the outer side surface 13 of the seat body 12. This fastens the upper bracket 40 to the rear of the seat body 12. The fastening bolt 78 functions as the central axis for the adjustment of the torso angle of the seat body 12.

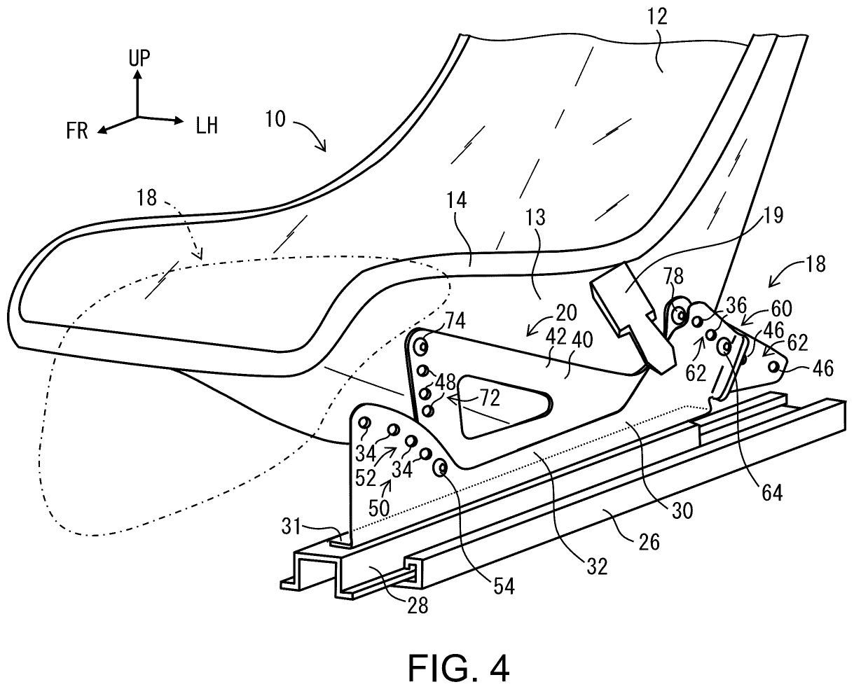

The bucket seat 10 of the present embodiment can provide four levels of adjustment. FIGS. 1 and 2 illustrate the seat body 12 at a first torso angle with the fastening bolt 74 inserted into the lowest bolt insertion hole 48. FIG. 4 illustrates the seat body 12 at a fourth torso angle with the fastening bolt 74 inserted into the uppermost bolt insertion hole 48. Although not illustrated, the seat body 12 is at a second torso angle when the fastening bolt 74 is inserted into the second bolt insertion hole 48 from the bottom. When the fastening bolt 74 is inserted into the third bolt insertion hole 48 from the bottom, the seat body 12 is at a third torso angle. In the torso angle adjustment, the fastening bolt 74 is inserted into the bolt insertion holes 48 located at the same height in the left and right side brackets 20 (the right side bracket 20 is not illustrated).

The bucket seat 10 of the present embodiment can perform the lifter adjustment in five levels. FIG. 1 illustrates the side bracket 20 in the first lifter position (lowest position). FIG. 3B illustrates the side bracket 20 in the second lifter position. FIG. 3C illustrates the side bracket 20 in the third lifter position. FIG. 3D illustrates the side bracket 20 in the fourth lifter position. FIG. 2 illustrates the side bracket 20 in the fifth lifter position (highest position).

In the first lifter position (lowest position), as illustrated in FIG. 1, the lowest bolt insertion hole 34 in the front part of the lower bracket 30, the lowest bolt insertion hole 36 in the rear part of the lower bracket 30, and the uppermost bolt insertion hole 46 in the rear part of the upper bracket 40 are used.

In the second lifter position, as illustrated in FIG. 3B, the second bolt insertion hole 34 from the bottom in the front part of the lower bracket 30, the second bolt insertion hole 36 from the bottom in the rear part of the lower bracket 30, and the uppermost bolt insertion hole 46 in the rear part of the upper bracket 40 are used.

In the third lifter position, as illustrated in FIG. 3C, the third bolt insertion hole 34 from the bottom in the front part of the lower bracket 30, the uppermost bolt insertion hole 36 in the rear of the lower bracket 30, and the uppermost bolt insertion hole 46 in the rear part of the upper bracket 40 are used.

In the fourth lifter position, as illustrated in FIG. 3D, the fourth bolt insertion hole 34 from the bottom in the front part of the lower bracket 30, the uppermost bolt insertion hole 36 in the rear of the lower bracket 30, and the second bolt insertion hole 46 from the bottom in the rear part of the upper bracket 40 are used.

In the fifth lifter position, as illustrated in FIG. 2, the uppermost bolt insertion hole 34 in the front part of the lower bracket 30, the uppermost bolt insertion hole 36 in the rear part of the lower bracket 30, and the lowest bolt insertion hole 46 in the rear part of the upper bracket 40 are used.

In the lifter adjustment, for each of the bolt insertion holes 34, 36, and 46, the fastening bolts 54, 64 are inserted into the bolt insertion holes 34, 36, and 46 at the same height on the left and right side brackets 20 (the right side bracket 20 is not illustrated).

Next, the operational effects of the bucket seat 10 of the embodiment described above will be described.

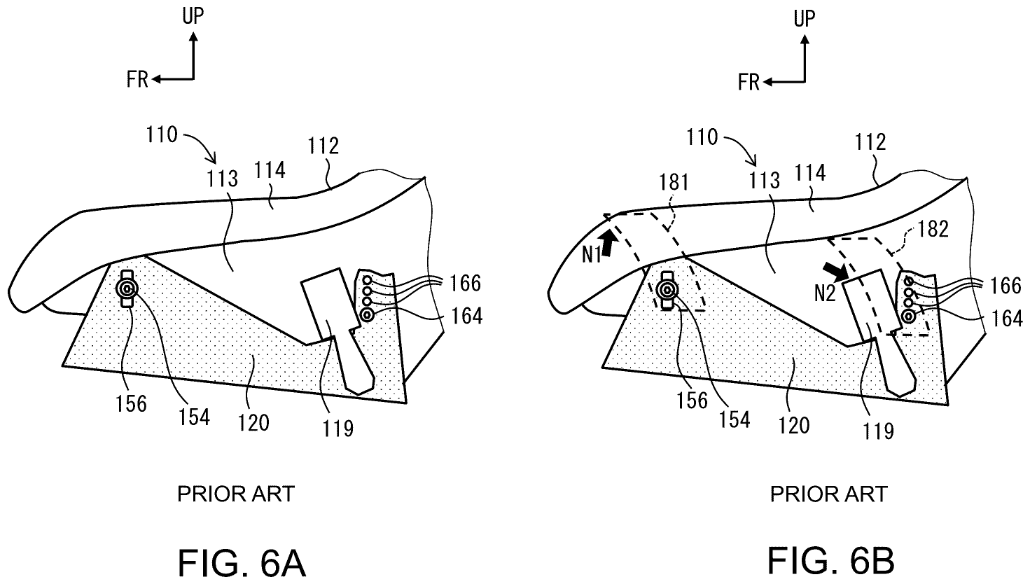

According to the embodiment described above, the side bracket 20 is made up of two parts; that is, the lower bracket 30 and the upper bracket 40, so that the lifter adjustment of the seat body 12 can be performed by changing the position of the upper bracket 40 with respect to the lower bracket 30 without changing the relative position of the seat body 12 and upper bracket 40. There is no need to provide the upward overhanging extensions 181, 182 as in the related art illustrated in FIG. 6B to expand the lifter adjustment range. The adjusters 52 and 62 can be provided in the fastening portions (front fastening portion 50 and rear fastening portion 60) of the lower bracket 30 and upper bracket 40, respectively, to expand the lifter adjustment range.

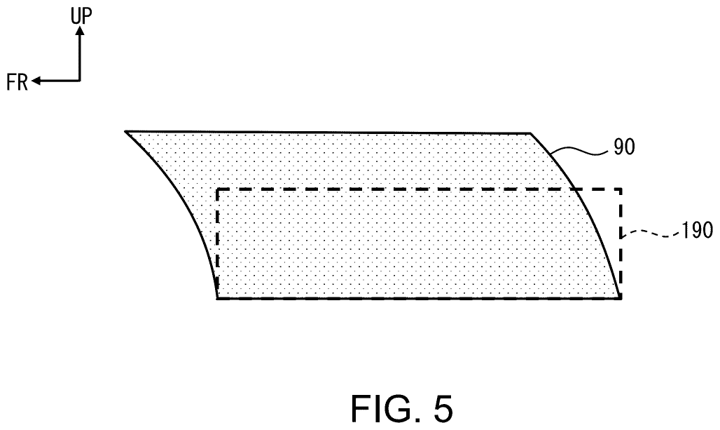

FIG. 5 schematically illustrates a lifter adjustment range 90 of the bucket seat 10 according to the embodiment described above and a lifter adjustment range 190 of the bucket seat 110 of the related art (see FIG. 6A). The lifter adjustment range 190 (FIG. 5) of the bucket seat 110 of the related art (see FIG. 6A) is limited to a narrow range in the up-down direction. In contrast, the lifter adjustment range 90 of the bucket seat 10 of the embodiment described above is expanded to a wider range in the front-back and up-down directions. Therefore, the seat body 12 can be sufficiently adjusted within the lifter adjustment range 90, and the seat body 12 can be set to the ideal driving position.

According to the embodiment described above, the inner buckle 19 of the seat belt is fastened to the upper bracket 40, so that the relative position of the inner buckle 19 with respect to the seat body 12 can be maintained before and after the lifter adjustment of the seat body 12. In the bucket seat 110 of the related art (see FIG. 6A), the inner buckle 119 is fastened to the side bracket 120 (a single part), and the relative position of the inner buckle 119 with respect to the seat body 112 changes before and after the lifter adjustment. This requires an additional labor of adjusting the position of the inner buckle 119 along with the lifter adjustment. In contrast, according to the embodiment described above, the relative position of the inner buckle 19 with respect to the seat body 12 does not affect the lifter adjustment, so that the position adjustment of the inner buckle 19 associated with the lifter adjustment can be omitted.

The bucket seat 10 described above has a form that allows the lifter adjustment in the front-back and up-down directions, but the bucket seat may also have a form that allows the lifter adjustment in the up-down direction only. In this case, the plurality of bolt insertion holes 34, 36 of the lower bracket 30 and the plurality of bolt insertion holes 46 of the upper bracket 40 are arranged in the up-down direction. Even in this case, the side bracket 20 is made up of two parts; that is, the lower bracket 30 and the upper bracket 40, so that the lifter adjustment range in the up-down direction can be expanded compared to the related art.

In the embodiment described above, the adjuster 52 of the front fastening portion 50 is provided as the plurality of bolt insertion holes 34 formed in the lower bracket 30, through which the fastening bolt 54 is selectively inserted according to the position of the upper bracket 40 with respect to the lower bracket 30 in the front-back and up-down directions or the up-down direction. The adjuster 62 of the rear fastening portion 60 is provided as the plurality of bolt insertion holes 36, 46 formed in the lower bracket 30 and the upper bracket 40, respectively, through which the fastening bolt 64 is selectively inserted according to the position of the upper bracket 40 with respect to the lower bracket 30 in the front-back and up-down directions or the up-down direction.

Alternatively, the adjusters 52 and 62 may have other forms. The adjuster 52 may be provided as the plurality of bolt insertion holes formed in at least one of the lower bracket 30 and the upper bracket 40, through which the fastening bolt 54 is selectively inserted according to the position of the upper bracket 40 with respect to the lower bracket 30. Similarly, the adjuster 62 may be provided as the plurality of bolt insertion holes formed in at least one of the lower bracket 30 and the upper bracket 40, through which the fastening bolt 64 is selectively inserted according to the position of the upper bracket 40 with respect to the lower bracket 30.

For example, one bolt insertion hole 34, or the plurality of bolt insertion holes 34 as the adjuster 52, may be provided in the front part of the lower bracket 30, while a plurality of bolt insertion holes 44 may be provided in the front lower part of the upper bracket 40 as the adjuster 52. For example, one bolt insertion hole 36 may be formed in the rear part of the lower bracket 30, and the plurality of bolt insertion holes 46 as the adjuster 62 may be provided in the rear lower part of the upper bracket 40. For example, the plurality of bolt insertion holes 36 may be formed in the rear part of the lower bracket 30 as the adjuster 62, and one bolt insertion hole 46 may be provided in the rear lower part of the upper bracket 40.

The plurality of bolt insertion holes in the adjusters 52 and 62 may be replaced by an elongate hole. The elongate hole is made by removing wall portions between the plurality of bolt insertion holes to make a single hole. The fastening bolts 54, 64 may be inserted into the bolt insertion hole or the elongate hole with washers.

1. A vehicle seat, comprising:
a seat body; and
a side bracket provided on an outer side on either side of the seat body, wherein
the side bracket includes an upper bracket and a lower bracket,
the upper bracket is fastened to an outer side surface of the seat body and is fastened to the lower bracket,
the lower bracket is fastened directly or indirectly to a vehicle floor,
the lower bracket and the upper bracket are fastened at a front fastening portion and a rear fastening portion, which are located apart from each other in a front-back direction of the seat body, and
the front fastening portion and the rear fastening portion each include an adjuster configured to change a position of the upper bracket with respect to the lower bracket in an up-down direction or in up-down and front-back directions to fasten the front fastening portion and the rear fastening portion together.

2. The vehicle seat according to claim 1, wherein
a buckle of a seat belt is fastened to the upper bracket of the side bracket.

3. The vehicle seat according to claim 1, wherein
the adjuster of the front fastening portion includes a plurality of front bolt insertion holes formed in a front part of the lower bracket, the plurality of front bolt insertion holes of the lower bracket including a selected front bolt insertion hole which is selected according to a position of the upper bracket with respect to the lower bracket, and
the front fastening portion includes
a front bolt insertion hole formed in a front part of the upper bracket, and
a front fastening bolt inserted into the front bolt insertion hole of the upper bracket and the selected front bolt insertion hole of the lower bracket.

4. The vehicle seat according to claim 2, wherein
the adjuster of the front fastening portion includes a plurality of front bolt insertion holes formed in a front part of the lower bracket, the plurality of front bolt insertion holes of the lower bracket including a selected front bolt insertion hole which is selected according to a position of the upper bracket with respect to the lower bracket, and
the front fastening portion includes
a front bolt insertion hole formed in a front part of the upper bracket, and
a front fastening bolt inserted into the front bolt insertion hole of the upper bracket and the selected front bolt insertion hole of the lower bracket.

5. The vehicle seat according to claim 1, wherein
the adjuster of the rear fastening portion includes
a plurality of rear bolt insertion holes formed in a rear part of the upper bracket, and
a plurality of rear bolt insertion holes formed in a rear part of the lower bracket,
the plurality of rear bolt insertion holes of the upper bracket include a selected rear bolt insertion hole which is selected according to a position of the upper bracket with respect to the lower bracket,
the plurality of rear bolt insertion holes of the lower bracket include a selected rear bolt insertion hole which is selected according to a position of the upper bracket with respect to the lower bracket, and
the rear fastening portion includes a rear fastening bolt inserted into the selected rear bolt insertion hole of the upper bracket and the selected rear bolt insertion hole of the lower bracket.

6. The vehicle seat according to claim 2, wherein
the adjuster of the rear fastening portion includes
a plurality of rear bolt insertion holes formed in a rear part of the upper bracket, and
a plurality of rear bolt insertion holes formed in a rear part of the lower bracket,
the plurality of rear bolt insertion holes of the upper bracket include a selected rear bolt insertion hole which is selected according to a position of the upper bracket with respect to the lower bracket,
the plurality of rear bolt insertion holes of the lower bracket include a selected rear bolt insertion hole which is selected according to a position of the upper bracket with respect to the lower bracket, and
the rear fastening portion includes a rear fastening bolt inserted into the selected rear bolt insertion hole of the upper bracket and the selected rear bolt insertion hole of the lower bracket.

7. The vehicle seat according to claim 3, wherein
the adjuster of the rear fastening portion includes
a plurality of rear bolt insertion holes formed in a rear part of the upper bracket, and
a plurality of rear bolt insertion holes formed in a rear part of the lower bracket,
the plurality of rear bolt insertion holes of the upper bracket include a selected rear bolt insertion hole which is selected according to a position of the upper bracket with respect to the lower bracket,
the plurality of rear bolt insertion holes of the lower bracket include a selected rear bolt insertion hole which is selected according to a position of the upper bracket with respect to the lower bracket, and
the rear fastening portion includes a rear fastening bolt inserted into the selected rear bolt insertion hole of the upper bracket and the selected rear bolt insertion hole rear fastening bolt of the lower bracket.

8. The vehicle seat according to claim 4, wherein
the adjuster of the rear fastening portion includes
a plurality of rear bolt insertion holes formed in a rear part of the upper bracket, and
a plurality of rear bolt insertion holes formed in a rear part of the lower bracket,
the plurality of rear bolt insertion holes of the upper bracket include a selected rear bolt insertion hole which is selected according to a position of the upper bracket with respect to the lower bracket,
the plurality of rear bolt insertion holes of the lower bracket include a selected rear bolt insertion hole which is selected according to a position of the upper bracket with respect to the lower bracket, and
the rear fastening portion includes a rear fastening bolt inserted into the selected rear bolt insertion hole of the upper bracket and the selected rear bolt insertion hole rear fastening bolt of the lower bracket.
